(19) United States
(12) Patent Application Publication
(10) Pub. No.: US 2026/0321767 A1
(43) Pub. Date: Oct. 15, 2026

(54) METHODS AND SYSTEMS FOR REGENERATION OF SOLID-STATE BATTERIES

(71) Applicant: William Marsh Rice University, Houston, TX (US)

(72) Inventors: James M. TOUR, Houston, TX (US); Jinhang CHEN, Houston, TX (US); Obinna ONAH, Houston, TX (US)

(73) Assignee: WILLIAM MARSH RICE UNIVERSITY, Houston, TX (US)

(21) Appl. No.: 19/191,153

(22) Filed: Apr. 28, 2025

Related U.S. Application Data
(60) Provisional application No. 63/639,805, filed on Apr. 29, 2024.

(51) Int. Cl. H01M 10/615; H01M 10/0562; H01M 10/0563; H01M 10/613; H01M 10/6571; H01M 50/609

(52) U.S. Cl. CPC H01M 10/615; H01M 10/0562; H01M 10/0563; H01M 10/613; H01M 10/6571; H01M 50/609; H01M 2300/002; H01M 2300/0068

(57) ABSTRACT

Methods and systems for regeneration of solid-state batteries, and more particularly, methods and systems for in-situ regeneration of oxide-based solid-state batteries by rapid annealing.

### CROSS-REFERENCE TO RELATED PATENT APPLICATIONS

The application claims priority to U.S. Patent Appl. Ser. No. 63/639,805, filed Apr. 29, 2024, entitled “Methods And Systems For Regeneration Of Solid-State Batteries,” which patent application is commonly owned by the owner of the present invention and is incorporated herein in its entirety.

### GOVERNMENT INTEREST

This invention was made with government support under Grant No. FA9550-22-1-0526, awarded by the Air Force Office of Scientific Research, and Grant No. W912HZ-21-2-0050, ERDC Army Corps of Engineers. The United States government has certain rights in the invention.

### TECHNICAL FIELD

The present invention relates to methods and systems for regeneration of solid-state batteries, and more particularly, methods and systems for in-situ regeneration of oxide-based solid-state batteries by rapid annealing.

### BACKGROUND

The car dealership model is to charge high fees for service throughout a car's lifetime. A major concern of auto dealerships is that electric vehicles (EV) require far less service, so they will not see the cars often to do routine repairs and maintenance. Hence, there is an effort afoot to develop batteries that could be periodically, such as 2× per year, regenerated (rejuvenated) to their original or near-original condition. By bringing the EV to the dealership on a routine basis, the dealership applies a protocol to the battery so that the battery is restored to its near original state. This could be an electrical treatment to the battery, or a chemical treatment, or both. In this manner, the dealership inspects the car routinely and thereby can replace filters, wiper blades, tires, etc. at the same time. But there is currently no way to regenerate a battery without disassembly and dissolution of the components. Hence, there is a need to regenerate a battery without disassembly and dissolution of the components.

Solid state batteries (SSBs) using solid electrolytes (as opposed to the far more common liquid electrolytes) have the potential to provide higher energy density, improved safety, and broader possible applications compared to conventional Li-ion batteries (LIBs) that use liquid electrolytes. The ionic conductivities of oxide and sulfide solid electrolytes can reach levels comparable with those of liquid electrolytes (~10⁻²-10⁻³ S cm⁻¹). [Wang 2020; Li 2023]. Oxide solid electrolytes, including Li garnets (for example, LiLa₃Zr₂O₁₂ (LLZO)), NASICON-type structures (for example, Li_{1.3}Al_{0.3}Ti_{1.7}(PO₄)₃ (LATP)) and perovskites (for instance, LiₓLa_{y}TiO₃ (LLTO)), have been widely investigated in solid-state batteries for their ion transport behavior [Kim 2021], electrochemical stability [Zhu 2016; Han 2016], interfacial properties [Wolfenstein 2018], and processability [Wolfenstein 2018; Nonemacher 2018]. Compared to sulfide solid electrolytes, oxides offer relatively wide electrochemical windows and can be paired with high-voltage cathodes (up to 5 V), critical for higher energy density. They also possess better stability in the air and against thermal runaway.

Continuous efforts have been focused on the all-solid-state lithium batteries (ASSLBs) with oxide electrolytes. However, oxides face two major drawbacks limiting current commercialization: the synthesis and processing of solid electrolyte films with high conductivity at a reasonable cost (~$100/kWh at the cell level) and the construction of stable interfaces with active materials and conductive additives. Recently, a new technique was developed by Wang et al. to sinter ceramics under high temperatures for a short duration. [Wang 2020]. Wang 2020 suggests that ultrafast sintering is essential to overcome the cost limitation compared to conventional furnace sintering. To cut the cost of production further, the technique has been extended from pellets to solid electrolyte films [Ping 2020], which are ready to be coordinated with existing slurry coating and battery pack assembly processes in the industry. The desired processing costs of solid electrolytes at <$4 m⁻² require an inexpensive fabrication procedure, including reduced temperature and duration and less use of inert gas or dry room facilities. [Balaish 2021]. In addition, the solid electrolytes layer should be as thin as possible (~20 μm, in the range of polymer separators) and mechanically robust to maximize the volumetric capacity.

Oxide solid electrolytes are rigid and brittle (high Young's modulus, low fracture toughness). The unfavorable mechanical properties induce point-to-point contact and inhibit intimate interface formation. Poor contact and interfacial instability, especially on the cathode side, have been observed in garnets [Zhu 2015; Richards 2016]and NASICONs. [Zhu 2016; Xiao 2019]. Applying polymeric buffer layers [Chen 2021], inorganic coating layers [Zhu 2022], or co-sintering with additive [Han 2018] have been explored to improve the interface contact. However, Li loss and side reactions result in a degradation in the long-term cycling performance.

### SUMMARY OF THE INVENTION

The present invention relates to methods and systems for regeneration of solid-state batteries, and more particularly, methods and systems for in-situ regeneration of oxide-based solid-state batteries by rapid annealing.

Embodiments of the present invention regenerate used oxide-based solid-state batteries by in-situ rapid Joule heating, to mitigate mechanical failure due to gap formation and reduce the resistance buildup on the interphases. Solid-state batteries (“SSBs”) based on oxide solid electrolytes are known for their high energy density and enhanced safety. However, large-scale fabrication is substantially limited by their high cost and unsatisfying stability. To solve this problem, non-flammable SSBs were designed that allow in-situ annealing and regeneration. For instance, the regenerated battery performance was demonstrated in the pellet-type and film-type design SSBs. The cell lifetime energy cost is dramatically decreased by introducing the additional number of cycles at a minimal fee. The regenerative design enables SSBs to maintain a high value as long as possible, thus benefiting the circular economy and improving energy efficiency.

In general, in one embodiment, the invention features a method that includes selecting a used battery comprising a solid-state electrolyte. The method further includes subjecting the battery to heating and cooling in situ to regenerate the used battery.

Implementations of the invention can include one or more of the following features:

The subjecting the battery to the heating and cooling to regenerate the used battery can include mitigating failure of the battery due to gap formation and reducing the buildup on interphases of the battery.

The battery can have gap formation resulting during battery cycling and side products accumulated after the battery cycling. The subjecting the battery to the heating and cooling in situ can enhance the performance of the battery upon usage by reducing the gap formation and the side product accumulated.

The battery can be a solid-state battery (SSB).

The battery can be a quasi-solid-state battery.

The solid-state electrolyte can be an LATP solid electrolyte.

The heating can be performed by flash Joule heating.

The heating can be performed by rapid thermal annealing.

The flash Joule heating can be performed through one or more electrical pulses.

The one or more electrical pulses can be delivered by direct current (DC), alternating current (AC), or pulse width modulation.

The battery can include a small amount of liquid electrolyte.

The liquid electrolyte can include a lithium salt.

The liquid electrolyte can include LiPF₆.

The liquid electrolyte can include a solubilized Li salt in a carbonate-based solvent, an ether-based solvent, or an ionic liquid.

A lithium salt can be added to the liquid electrolyte.

The lithium salt can be a lithium carbonate.

After the subjecting the battery to the heating and cooling, the method can include adding liquid electrolyte to the battery.

The battery can be reconditioned, rejuvenated, and/or enhanced in its electrical performance after the adding of the liquid electrolyte.

The battery can be reconditioned, rejuvenated, and/or enhanced in its electrical performance as a result of the heating and cooling.

The battery can include a high temperature sealant applied to a cell gap of the battery.

The heating can be performed at a heating temperature between 150 °C and 1000 °C.

The heating temperature can be at least to 500 °C.

The heating temperature can be to at least to 750 °C.

The heating can be performed at a heating temperature of at least 1000 °C.

The heating can be applied for a period between 1 second and 3 minutes.

The heating can be applied for a period of less than 1 second.

In general, in another embodiment, the invention features a system that includes a source including a used battery having a solid-state electrolyte. The systems further includes a battery heater and annealer. The battery heater and/or annealer is operable to subject the battery to heating and cooling in situ to regenerate the used battery to a regenerated battery.

Implementations of the invention can include one or more of the following features:

The system is capable of performing one or more of the above-described methods to regenerate the used battery in situ.

The battery regenerator includes a flash Joule heating system.

### BRIEF DESCRIPTION OF THE DRAWINGS

FIGS. 1A-1E show design of solid-state batteries and photos of the electrodes. FIG. 1A is an illustration diagram of the pellet-type cell. FIG. 1B is a picture of both sides of the pellet. FIG. 1C is an illustration diagram of the film-type cell. FIG. 1D is a picture of composite cathode coated on Ti foil. FIG. 1E is a picture of cathode after LATP spray coating.

FIGS. 2A-2D show SEM images of the pellet and corresponding elemental mapping. FIG. 2A shows a cross-section SEM image. FIG. 2B shows elemental mapping of the pellet. FIGS. 2C-2D show top-view SEM images of, respectively, LCO composite cathode and LTO composite anode.

FIGS. 3A-3E show characterizations of the film electrode. FIG. 3A shows XRD patterns of film-coated cathode before and after LATP coating. FIG. 3B shows an SEM image of LCO-LATP composite cathode. FIGS. 3C-3E show SEM images of LCO-LATP composite cathode after LATP coating.

FIGS. 4A-4E show characterizations of the spray-coated and drop-coated electrodes. FIG. 4A shows pictures of spray-coated and drop-coated electrodes. FIGS. 4B-4C show, respectively, top-view SEM images of drop-coated and spray-coated electrodes. FIGS. 4D-4E show, respectively, cross-section SEM images of drop-coated and spray-coated electrodes.

FIGS. 5A-5E show battery design and regeneration process. FIG. 5A shows a schematic diagram of the in-situ regeneration process in SSBs. FIG. 5B shows film-type and pellet-type configurations of oxide-based SSBs in coin cells. FIGS. 5C-5E show thermal stability test of assembled battery sealed with silicone sealant (with FIGS. 5D-5E showing before and after, respectively).

FIGS. 6A-6C show pictures of heated carbon felt under different temperatures (600 °C-800 °C, 1000 °C-1300 °C, and 1500 °C-2000 °C, respectively).

FIGS. 7A-7E show thermal stability of a first type of silicone sealant under high temperature 750 °C. FIG. 7A shows a photograph of the first type of silicone sealant. FIGS. 7B-7E show, respectively, the first type of silicon sealant as applied, cured for 12 hours, 700 °C for 30 seconds, and 1100 °C for 10 seconds.

FIGS. 8A-8E show thermal stability of a first type of silicone sealant under high temperature 1000 °C. FIG. 8A shows a photograph of the second type of silicone sealant. FIGS. 8B-8E show, respectively, the second type of silicon sealant as applied, cured for 12 hours, 700 °C for 30 seconds, and 1100 °C for 10 seconds.

FIGS. 9A-9B show battery performance tests of regenerable SSBs. FIG. 9A shows cycling performance after ex-situ regeneration of LTO∥LATP∥LCO pellet-type battery. FIG. 9B shows cycling performance after in-situ regeneration of Graphite ∥LATP∥LCO-LATP film-type battery.

FIGS. 10A-10B show photos of the coin cell during rapid annealing. FIG. 10A shows a picture of the coin cell during rapid annealing. FIG. 10B shows a picture of the disassembled anode and cathode after rapid annealing.

FIGS. 11A-11B show battery performance tests after optimization. FIG. 11A shows a voltage-capacity profiles with polypropylene separators and LATP solid electrolytes. FIG. 11B shows cycling performance of optimized pre-lithiated Graphite ∥LATP∥LCO-LATP battery.

FIG. 12 shows a regeneration workflow for a system that can be utilized for performing the method to regenerate waste solid-state batteries.

### DETAILED DESCRIPTION

The present invention relates to methods and systems for regeneration of solid-state batteries, and more particularly, methods and systems for in situ regeneration of oxide-based solid-state batteries by rapid annealing.

The present invention addresses the regeneration in situ, while the battery remains as a whole unit. This is done through rapid thermal annealing (RTA) or rapid Joule heating, and the addition of a trace of liquid treatment to replace what had been lost during the Joule heating. In order to perform Joule heating to a high temperature, the electrolyte is a solid electrolyte rather than a liquid electrolyte. Hence, a solid-state battery (SSB) is used since liquid electrolytes decompose at high temperature.

To utilize such ultrafast synthesis techniques of oxide ceramic solid electrolytes, an intimate cathode interface was constructed through rapid sintering without serious Li loss and interdiffusion. The cycling stability of oxide-based batteries has been extended to 200 cycles (paired with LiCoO₂ (LCO) and LiNi_{0.8}Mn_{0.1}Co_{0.1} (NMC) cathodes) [Chen 2024], and 500 cycles (paired with LiFePO₄ (LFP) cathode) [Yao 2024] for the first time in the pellet-type cells. These works pave the way for practical applications of oxide solid electrolytes in high-energy-density SSB development.

Although the promising capacity and high reversibility of the oxide-based SSBs have been demonstrated against high-voltage cathodes, the number of cycles (~500 cycles) is still far from those of commercial lithium-ion batteries (LIBs) (2000-3000 cycles). The solid electrolytes and active materials from used SSBs undergo separation, recovery, and regeneration before they are reused. [Tan I 2020; Tan II 2020]. The solution-based separation and re-lithiation by thermal annealing processes significantly contribute to the overall cost of achieving the circular economy.

Embodiments of the present invention utilize a regeneration method for oxide-based SSBs, which enables a simple, rapid annealing process at ~750 C to restore the initial capacity. Such rapid annealing process can be conventional rapid thermal annealing processes or flash Joule heating processes. The annealing treatment can mitigate mechanical failure by welding the gaps and voids formed during cycling and decomposing the side products/passivating interphase. After annealing, a small amount of liquid electrolyte can be added to wet and recondition the SSB. The energy consumption, greenhouse gas (GHG) emissions, and cost of the regeneration are significantly lower than in the conventional recycling method. [Ahuis 2024].

For the in-situ regeneration of SSBs, oxide-based SSBs were designed and fabricated.

### LATP Solid Electrolyte Synthesis

Lithium aluminum titanium phosphate (LATP) is a sodium superionic conductor (NaSICON) structure solid state electrolyte for solid state battery applications. LATP solid electrolyte was synthesized by mixing Li₂CO₃, Al₂O₃, TiO₂, and NH₄H₂PO₄ stoichiometrically (10 wt % access of Li₂CO₃ to mitigate Li loss) through ball milling in isopropyl alcohol at 400 rpm for 6 h. The mixed precursors are dried and annealed in a furnace at 850 °C for 8 h to obtain LATP powders. Such LATP powders were used to design and fabricate the SSBs. Alternatively, LATP powders can be obtained commercially, such as MSE PRO Solid Electrolyte LATP 300 nm Powder Lithium Aluminum Titanium Phosphate from MSE Supplies (Tucson, Arizona).

### SSB Design and Fabrication

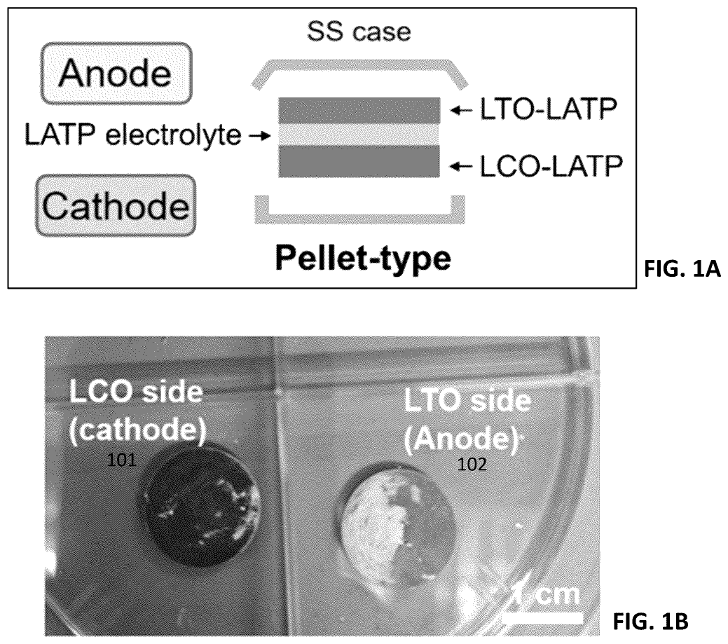

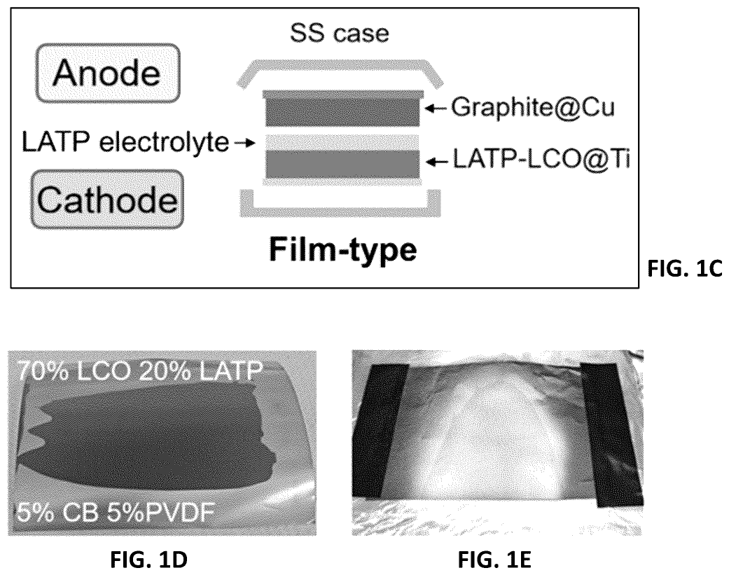

Two representative types of battery configurations were designed and fabricated for investigation and analysis, including pellet-type and film-type. FIGS. 1A-1E. In the pellet-type SSB (illustrated in FIG. 1A), Li₄Ti₅O₁₂ (LTO) and LiCoO₂ (LCO) were tested as the anode and cathode, respectively. The composite anode and cathode were composed of 75% active materials, 20% LATP, 3% CB, 2% PVDF binder (by mass).

To fabricate the tri-layer pellet monolith, LATP powder was cold-pressed to a 15 mm pellet using a die set (~200 MPa). Then the anode powder was spread and cold-pressed under the same pressure on one side while the cathode powder was pressed on the other side (FIG. 1B with LCO side (cathode) 101 and LTO side (anode) 102). The obtained pellet was rapid-sintered at 850 °C for 10 s to enhance physical contact. [Chen 2024].

In the film-type SSB (illustrated in FIG. 1C), graphite and LCO were tested as the anode and cathode, respectively. The anode and cathode slurries (FIG. 1D) were prepared by mixing 70% active material, 20 % LATP, 5% CB and 5% PVDF in N-methyl-2-pyrrolidone (NMP). Cu foil (8 μm thickness) was used as the anodic current collector and Ti (or Ni foil) was used as the cathodic current collector. The slurries were coated on the current collectors by doctor blade and dried in the vacuum oven overnight. The LATP solid electrolyte layer was coated on the cathode by spray-coating. LATP powder was ball-milled (400 rpm, 4 h) and dispersed in ethanol. The suspension was spray-coated to form a continuous layer on the cathode (FIG. 1E) on a hot plate. A similar scalable coating process for SSBs was demonstrated in Tan II 2020, indicating that the film coated SSB configuration holds promise to coordinate with current techniques.

### SSB Characterizations

The designed and fabricated batteries having the representative types of battery configurations were characterized.

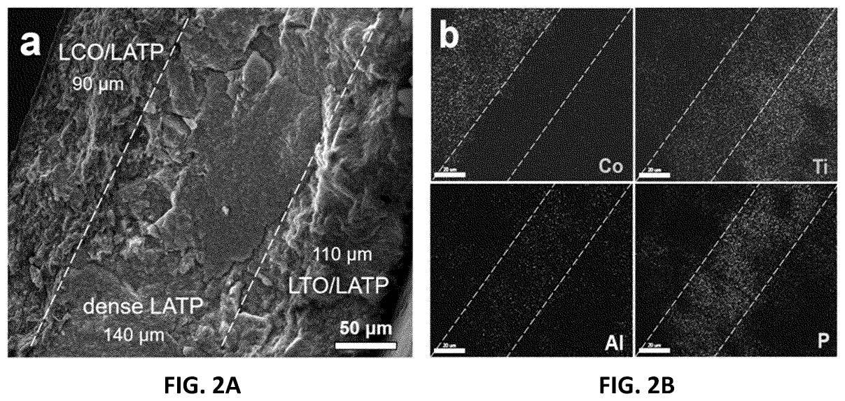

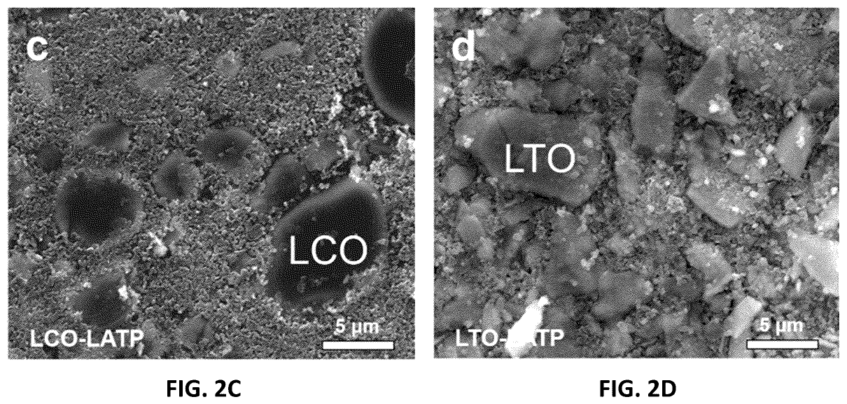

The pressed pellet was characterized by scanning electron microscope (SEM) images and corresponding element mapping. FIGS. 2A-2D. A tri-layer configuration with dense solid electrolyte layer and composite electrode layers could be observed from the cross-section SEM images. See FIG. 2A. The element mapping confirmed the structure. FIG. 2B. The LCO layer (shown in Co), solid electrolyte layer (shown in Ti, P and Al), and the LTO layer (shown in Ti) are well separated. The top-view SEM images of FIGS. 2C-2D showed, respectively, that LCO and LTO particles with the size of 5-10 μm were uniformly dispersed in the LATP network.

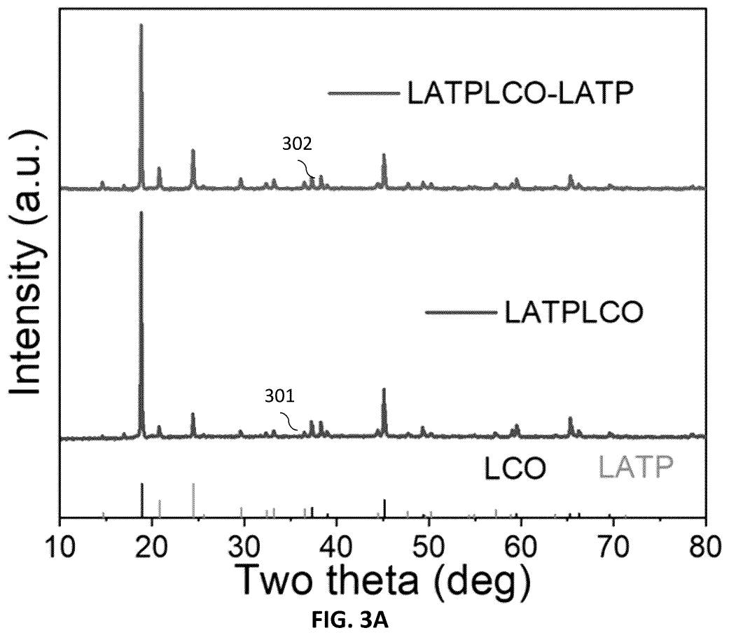

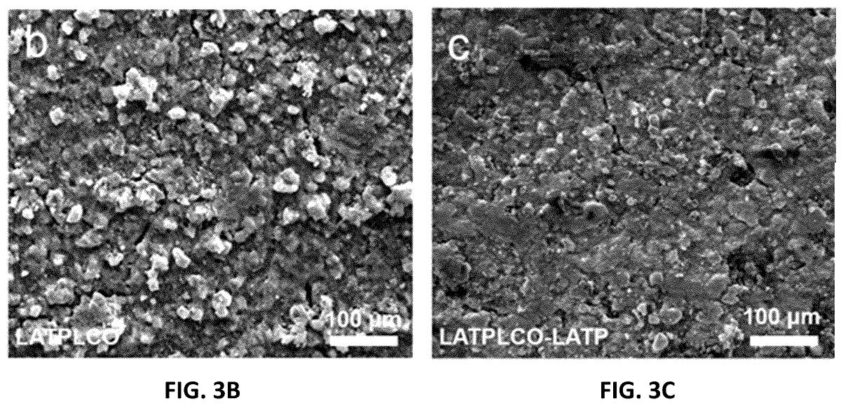

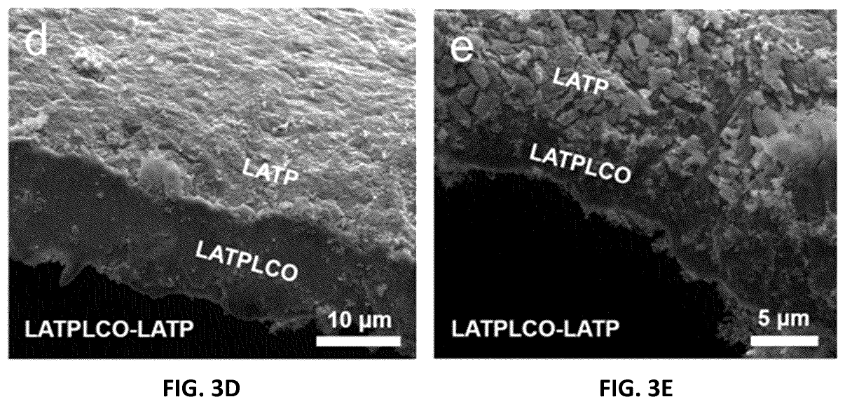

The composite cathode coated on Ti foil was characterized by X-ray diffraction (XRD) analysis. FIG. 3A. The peaks at 18.9° and 24.5° correspond to (003) and (113) facets of LCO and LATP, respectively. The LATP intensity relative to the LCO signal increased after the cathode was spray-coated with LATP, which indicates the surface deposition of LATP. The surface morphology was analyzed using SEM images. FIGS. 3B-3E. LCO particles were well dispersed on the surface (FIG. 3B) before the spray coating. The LATP layer could be observed from the top view (FIG. 3C) and cross-section images (FIGS. 3D-3E) after the spray-coating. The coated LATP layer can serve as the insulating separator and Li-ion conductor in the battery configuration.

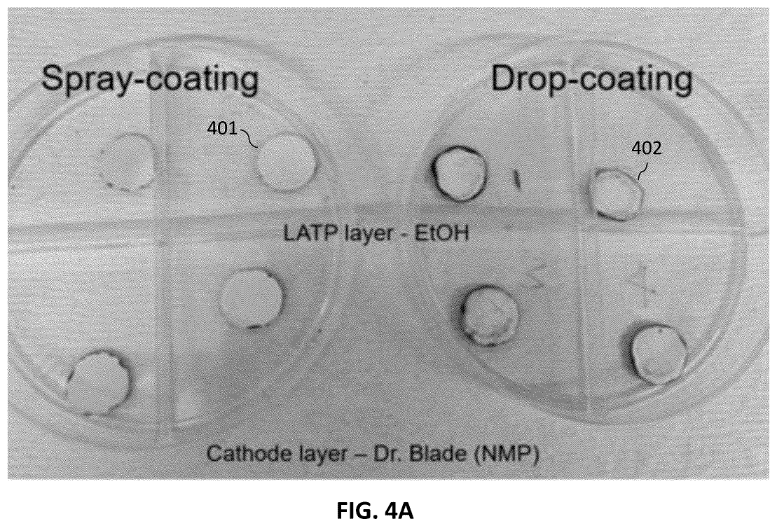

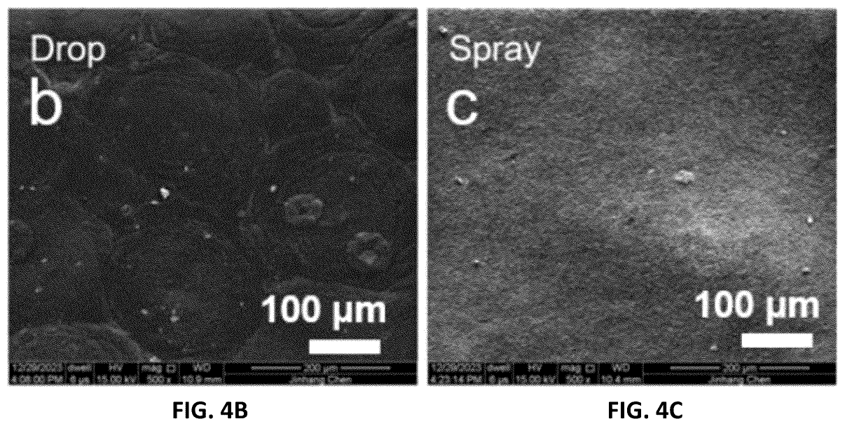

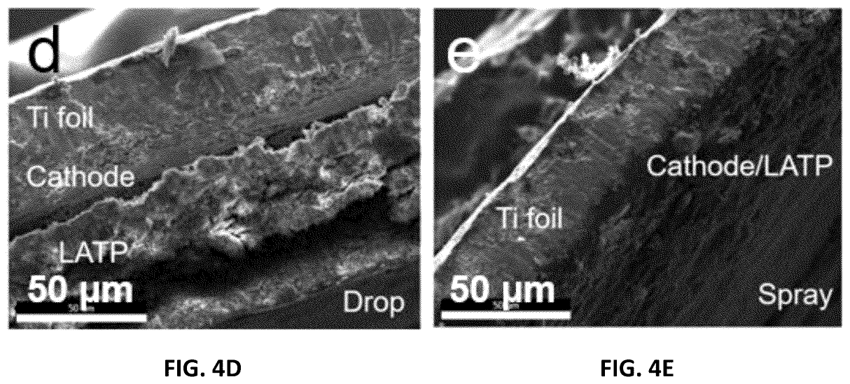

The spray coating method was also compared to the drop coating method. The surface morphology of spray-coated samples is smoother and more uniform than the drop-coated samples. FIG. 4A (with spray-coated electrodes 401 and drop-coating electrodes 402); FIGS. 4B-4C. Obvious cracks were observed on the drop-coating sample. The cross-section SEM images suggested that the drop-coated LATP layer is not densely packed on the electrode. FIGS. 4D-4E. The thickness of the spray-coated LATP layer was much thinner, which reduces the use of solid electrolytes, thus increasing the energy density of the SSB.

The coating effect on different current collectors was further analyzed. The target regeneration temperature was ~750 °C. Metals with high melting points and high electrical conductivity were favorable. Cu was selected as the anodic current collector, while Ni and Ti are possible candidates for the cathodic current collector. The metal foil with 0.01 mm thickness was used for coating because of the better adhesion between the foil and the composite cathode than the films with a thickness of 0.03 mm or 0.05 mm.

### Electrochemical Testing of SSBs

The designed and fabricated batteries having the representative types of battery configurations were electrochemically tested. The battery performance was tested in the 2032-type coin cells. The cells were assembled in an Ar-filled glovebox (O₂ and moisture content <0.5 ppm). The pellet-type battery was assembled with 5 μL liquid electrolyte addition on the cathode side. The film-type battery was assembled with 5 μL liquid electrolyte addition between the anode and cathode. The liquid electrolyte was prepared by dissolving 1 M LiPF₆ in 3:7 (by volume) ethyl carbonate (EC):ethyl methyl carbonate (EMC).

The cycling performance of oxide-based SSBs could be significantly improved with a small amount of liquid electrolyte to wet the surface, which is considered as quasi-solid. For the non-flammable battery design, the polypropylene O-ring used for sealing was removed, and 3M Fire Block Sealant FB 136 (3M, St. Paul, Minnesota) was applied to the gap of cells. After the regeneration process, 5 μL liquid electrolyte was added into the cell through a sealable piercing before the battery test.

### In-Situ Regeneration Process

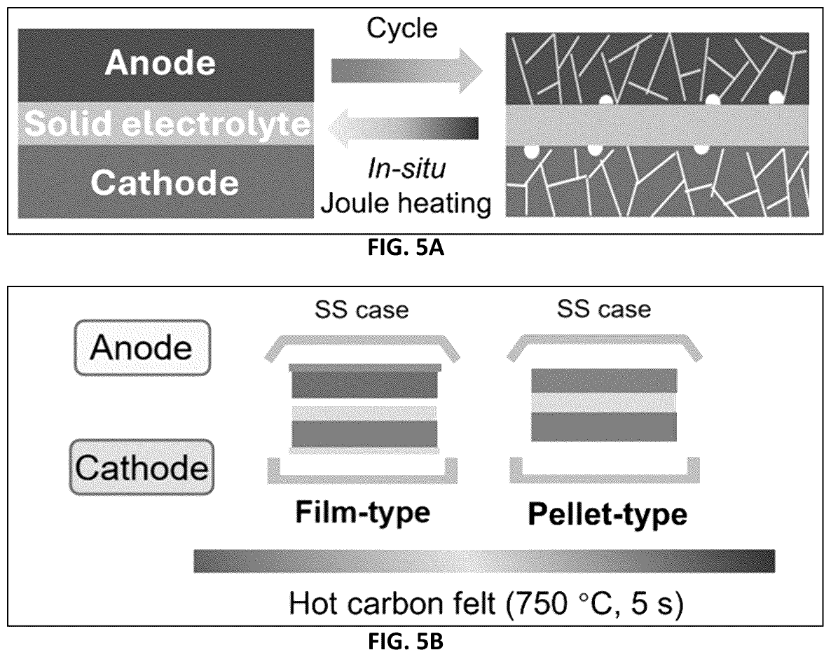

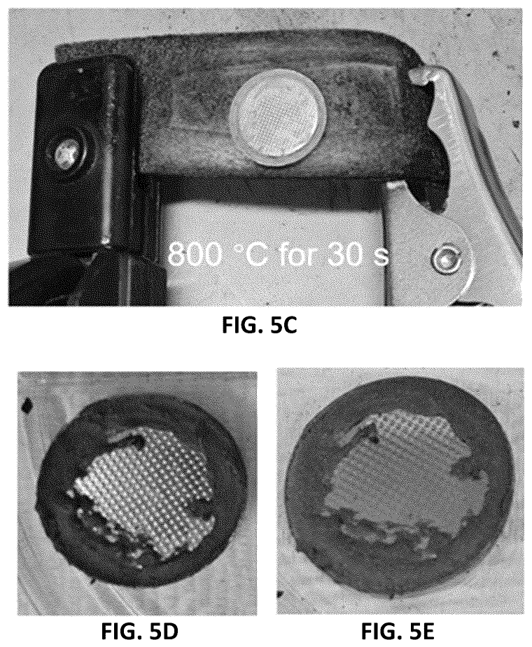

FIGS. 5A-5E show battery design and regeneration process. The target goal and results of this in-situ registration process is illustrated in FIG. 5A. The in-situ annealing aims to repair the gap formation during battery cycling and remove the side products accumulated after cycling.

This process was tested on pellet-type and film-type coin. See FIG. 5B. The flammable polypropylene O-ring used for coin-cell sealing was replaced by thermal-resistant silicone sealant. The rapid annealing was achieved by heating a carbon felt connected to a $125 commercial arc welder (DekoPro 110/220V MMA welder, 160A ARC, welder machine, IGBT digital display, LCD, hot start welder, Deko Tools, Inc., Toledo, Ohio). The real-time temperature was monitored with an infrared thermometer.

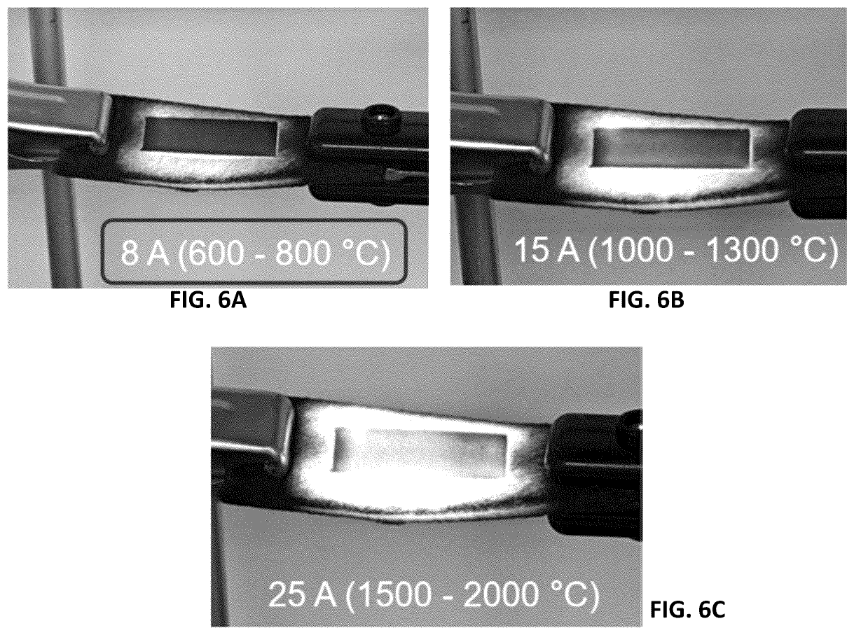

The carbon felt temperature could be controlled by adjusting the current of the arc welder. See FIGS. 6A-6C. In some embodiments, the optimized regeneration condition was at 750 °C for 5 s. The optimized regeneration condition for these embodiments was found to be at 750 °C for 5 s. The rapid annealing can also be performed using a flash Joule heating process or other processes that perform quick resistive heating. Alternatively, a conventional rapid thermal annealing instrument could be used to carry out the same process. Similar electrical performance has been observed in devices annealed using a conventional rapid thermal annealing (RTA, sometimes called Rapid Thermal Processing, RTP) system, indicating that the annealing process is not limited to flash Joule heating processes. The device and operating mechanism are compatible with standard RTA or RTP equipment, and FJH serves as one of several viable options for thermal processing.

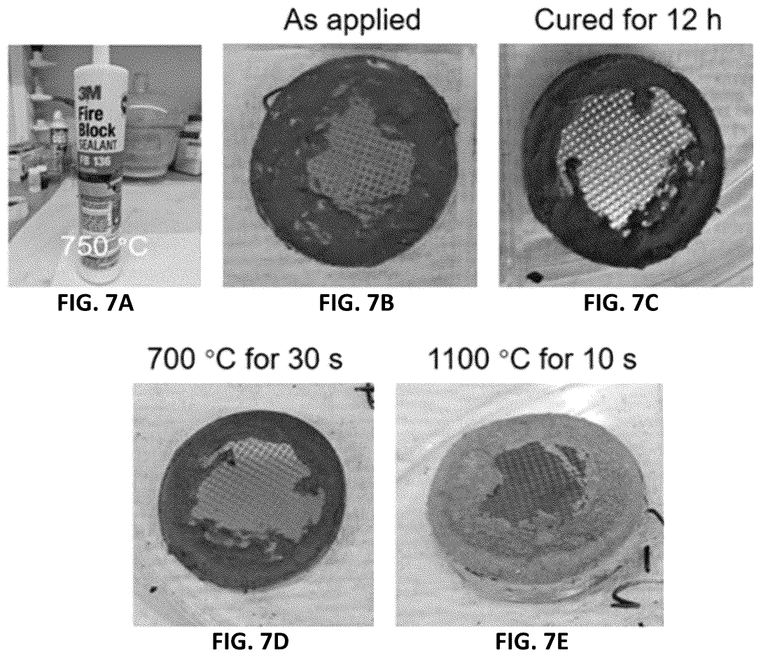

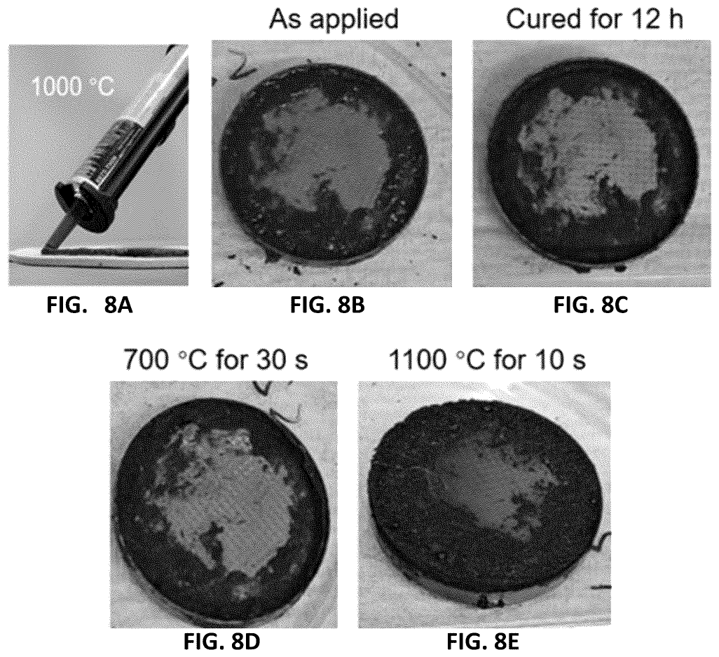

The thermal stability of the battery was tested under 800 °C for 30 s. FIG. 5C. No obvious change on the cell was noticed before and after the annealing (FIGS. 5D-5E, respectively), indicating a promising result of thermal stability of the components in the SSB design. Two types of silicone sealant showed stability under similar conditions at ~700 °C but the decomposition started at ~1100 °C. See FIGS. 7A-7E and 8A-8E.

Initial capacity can be restored after an in-situ annealing and electrolyte injection of the coin cell. A resealable hole was designed for the 5-microliter liquid electrolyte re-wetting process. For example, a liquid electrolyte that was 1.0 M LiPF₆ electrolyte (in EC:DMC=3:7 by volume) was used. (Other liquid electrolytes, such as those containing Li salts dissolved in carbonate or ether solvent can also be used). The possible mechanism for the regeneration is the mitigation of mechanical failure and the decomposition of the formed solid-electrolyte interface and side products. The cycling performance of oxide-based SSBs can be significantly improved with this small amount of liquid electrolyte to wet the surface, which is considered as quasi-solid system.

After repeated regeneration, there might be small amounts of lithium loss. This can be solved by adding small amounts of lithium salts, like lithium carbonate, to the small liquid electrolyte addition after annealing.

### Battery Performance of SSBs

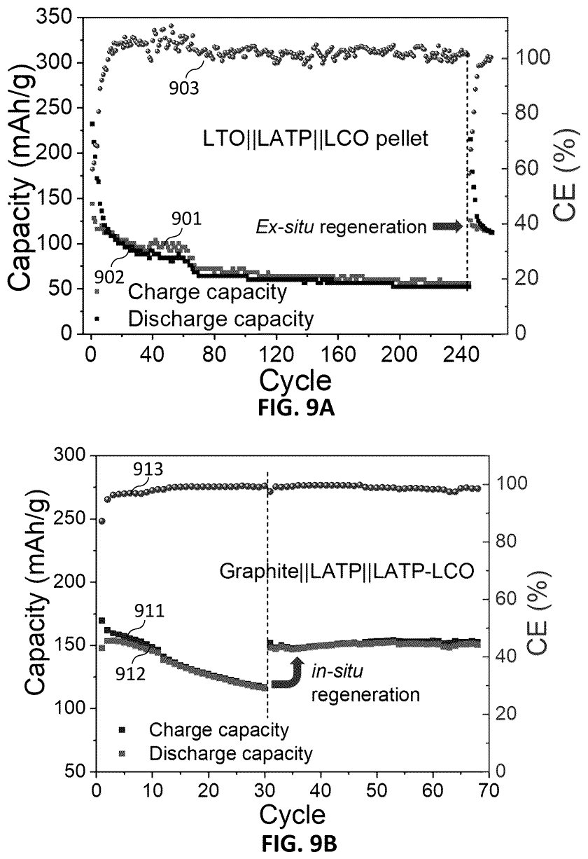

The battery capacity recovery after regeneration is demonstrated in FIGS. 9A-9B. The ex-situ process was performed on pellet-type SSBs by disassembling the cell and annealing the pellet at 750 °C for 5 s. The pellet was re-assembled and tested after 5 μL liquid electrolyte addition. Initial capacity can be restored after the ex-situ annealing process (FIG. 9A with plots 901-903 for charge capacity, discharge capacity, and coulombic efficiency (CE), respectively), suggesting the annealing process serves as an efficient strategy for oxide-based SSB regeneration. The decomposed interphase was reconstructed after the treatment during the battery cycling.

The in-situ process of film-type SSBs was further analyzed. The capacity restored after the in-situ annealing and liquid electrolyte injection. FIG. 9B (with plots 911-913 for charge capacity, discharge capacity, and CE, respectively).

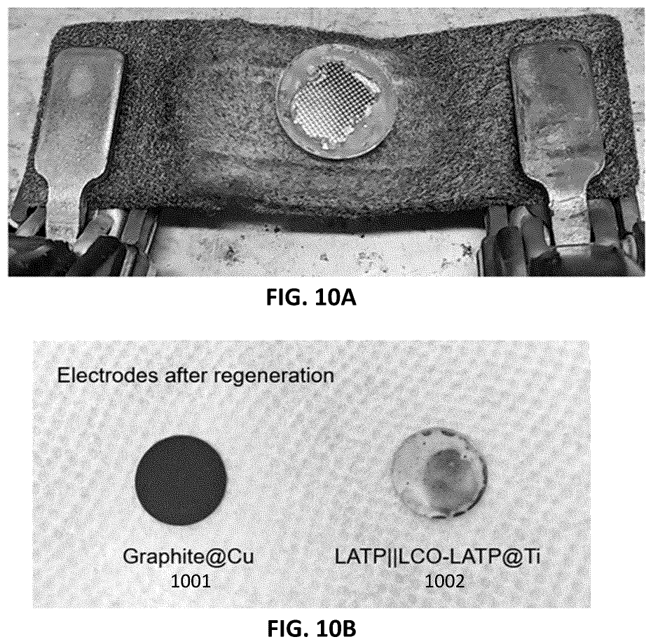

Uniform heat dissipation on the carbon felt could be seen during the annealing. FIG. 10A. After the process, the materials-loaded current collectors remained stable and surface of graphite anode 1001 and LATP∥LCO-LATP cathode 1002 became clean. FIG. 10B.

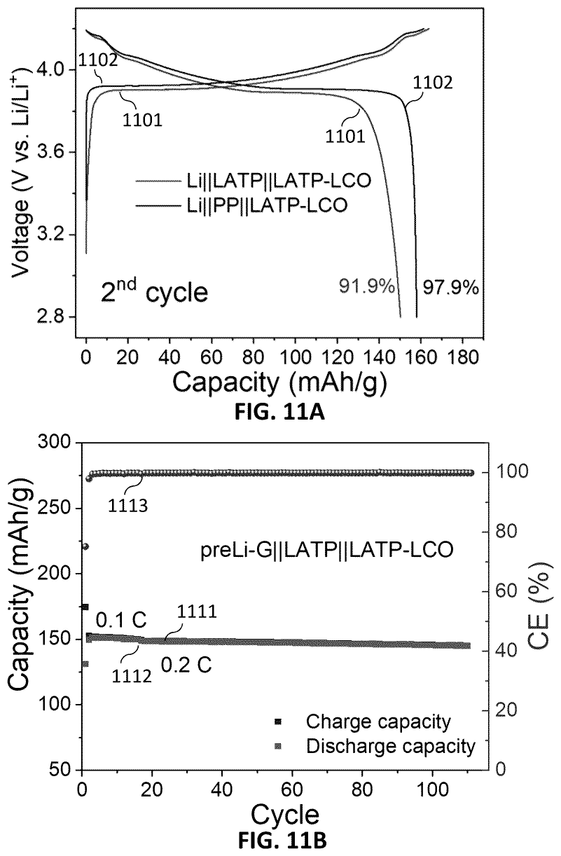

The battery performance was further analyzed and optimized by controlling the thickness of LATP layer. Thin LATP solid electrolyte resulted in short-circuit behavior after cycling while thick LATP layer caused lower capacity and coulombic efficiency (CE). The LATP-coated cathode demonstrated similar charging and discharging behavior compared to batteries with commercial polypropylene separators. FIG. 11A (with plots 1101-1102 for Li∥LATP∥LATP-LCO and Li∥PP∥LATP-LCO, respectively). By pre-lithiating the graphite anode, the film-type SSB exhibited high cycling stability. FIG. 11B (with plots 1111-1113 for charge capacity, discharge capacity, and CE, respectively).

### Applications and Advantages

The development of SSBs is largely limited by their high cost and low stability. Convenient regeneration methods are urgently needed. Benefiting from the high electrochemical and thermal stabilities of oxide-type solid electrolytes, an in-situ regeneration method of SSBs has been demonstrated. Notably, it is believed that this is the first time that a LIB has been regenerated in situ. In all other cases, the LIBs need to be deconstructed, and most often the components (anode, cathode, electrolyte, separator, and current collector) need to be separated, separately processed (most often using wet chemical methods including strong acids) and thereby recycled, and then reassembled. This is most often highly labor intensive and requiring harsh chemical treatment and secondary-waste-generating (acid stream); the waste stream needs its own reprocessing and recycling. The in-situ regeneration method described here obviates all these steps.

The regeneration is carried out only through electricity-induced rapid annealing, which accounts for <5% of the initial cost of the cell, and is finished in 5 seconds. The technique has been verified in a coin cell and can be utilized in other batteries, such as in layered pouch cells and rolled cell constructions, like D-type cells, or any design that has materials able to withstand the high temperature process for seconds. Such processes for regenerating can be repeated multiple times, such as at least four times, by rapid annealing. The SSB can deliver a specific energy of 300 Wh/kg each cycle at the test cell capacity over 1 Ah.

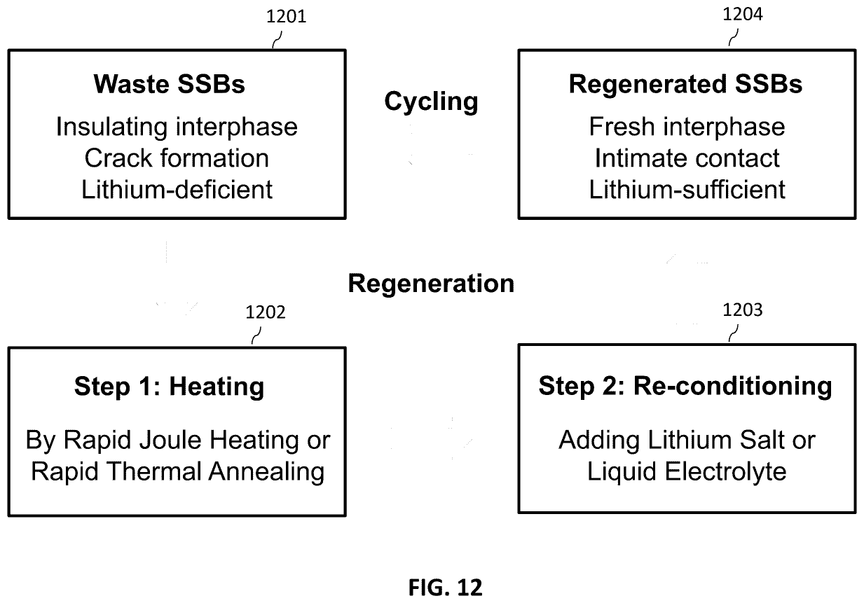

For instance, a system can be utilized to perform the method shown in the regeneration workflow in FIG. 12, to regenerate used batteries. The system includes a source 1201 that includes a used (i.e., waste) solid-state batteries. The used batteries can have insulating interphase, crack formation, lithiuim deficiency, etc. The system further includes a battery heater/annealer system 1202 that is capable to subject the used batteries (obtained from the source 1201) to heating and cooling in situ the used batteries. The heater/annealer system 1202 can be, for instance, a rapid Joule heating system or a rapid thermal annealing system. Such rapid Joule heating system can be, for example, the systems shown in PCT Patent Appl. Serial Nos. PCT/US21/52030, PCT/US21/52043, PCT/US21/52057, and PCT/US21/52070, to James M. Tour et al., each entitled “Ultrafast Flash Joule Heating Synthesis Methods And Systems For Performing Same,” each filed Sep. 24, 2021 (collectively “the Tour '070 PCT Applications”), which are incorporated herein in their entirety.

After heating/annealing, the batteries are reconditioned in a battery reconditioner 1203, such as by adding lithium salt or liquid electrolyte. The regenerated solid-state batteries (in output 1204) have fresh interphase, intimate contact, lithium-sufficiency, etc. The regenerated solid-state batteries can then be used resulting in waste solid-state batteries.

For the in-situ SSB regeneration by rapid annealing process, (i) the in-situ battery regeneration process has never before been achieved due to their complex battery chemistry, complicated cell designs, and limited reconditioning strategies; (ii) the failure mechanism of oxide-type SSBs is elucidated and the thermal-resistant cell design here solves that problem; (iii) the rapid annealing process is convenient, and energy-saving compared to conventional wet separation and furnace relithiation processes; and (iv) the process can be utilized to extend to other battery configurations, including various anodes, cathodes and solid electrolytes.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. The scope of protection is not limited by the description set out above, but is only limited by the claims which follow, that scope including all equivalents of the subject matter of the claims.

It is believed the cell can be cycled, for example, for 1000 cycles and regenerated four times, allowing 5,000_cycles under high specific energy. The coating parameters can be adjusted for optimization, and other active materials can be utilized, such as LiFePO₄ (LFP), LiNiₓMn_{y}CO_{1-x-y}O₂ (NMC) for the cathode and _SiC, anode-free design for the anode. The technique can be utilized on a pouch cell level.

The disclosures of all patents, patent applications, and publications cited herein are hereby incorporated herein by reference in their entirety, to the extent that they provide exemplary, procedural, or other details supplementary to those set forth herein.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a” and “an” mean “one or more” when used in this application, including the claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

As used herein, the term “about” and “substantially” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, the term “substantially perpendicular” and “substantially parallel” is meant to encompass variations of in some embodiments within ±10° of the perpendicular and parallel directions, respectively, in some embodiments within ±5° of the perpendicular and parallel directions, respectively, in some embodiments within ±1° of the perpendicular and parallel directions, respectively, and in some embodiments within ±0.5° of the perpendicular and parallel directions, respectively.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

### REFERENCES

U.S. Patent Appl. Publ. No. 2022/0219986, entitled “High Temperature Sintering Systems And Methods,” L. Hu, et al., filed Nov. 16, 2021 (“Hu '986 Application”).
Ahuis, M., et al., “Recycling of solid-state batteries,” Nat. Energy, 2024, 1-13 (“Ahuiis 2024”).
Balaish, M., et al., “Processing thin but robust electrolytes for solid-state batteries,” Nat. Energy, 2021, 6, 227-239 (“Balaish 2021”).
Chen, J., et al., “Cathode Interface Construction by Rapid Sintering in Solid-State Batteries,” Small, 2024, 20, 2307342 (“Chen 2024”).
Chen, Z., et al., “Highly Stable Quasi-Solid-State Lithium Metal Batteries: Reinforced Li_{1.3}Al_{0.3}Ti_{1.7}(PO₄)₃/Li Interface by a Protection Interlayer,” Adv. Energy Mater., 2021, 11, 2101339 (“Chen 2021”).
Han, F., et al., “Interphase Engineering Enabled All-Ceramic Lithium Battery,” Joule, 2018, 2, 497-508 (“Han 2018”).
Han, F., et al., “Electrochemical Stability of Li₁₀GeP₂S₁₂ and Li₇La₃Zr₂O₁₂ Solid Electrolytes,” Adv. Energy Mater., 2016, 6, 1501590 (“Han 2016”).
Kim, K. J., et al., “Solid-State Li-Metal Batteries: Challenges and Horizons of Oxide and Sulfide Solid Electrolytes and Their Interfaces,” Adv. Energy Mater., 2021, 11, 2002689 (“Kim 2021”).
Li, Y., et al., “A lithium superionic conductor for millimeter-thick battery electrode,” Science, 2023, 381, 50-53 (“Li 2023”).
Nonemacher, J. F., et al., “Microstructure and properties investigation of garnet structured Li₇La₃Zr₂O₁₂ as electrolyte for all-solid-state batteries,” Solid State Ion., 2018, 321, 126-134 (“Nonemacher 2018”).
Ping, W., et al., “Printable, high-performance solid-state electrolyte films,” Sci. Adv., 2020, 6, eabc8641 (“Ping 2020”).
Richards, W. D., et al., “Interface Stability in Solid-State Batteries,” Chem. Mater., 2016, 28, 266-273 (“Richards 2016”).
Tan, D. H. S., et al., “From nanoscale interface characterization to sustainable energy storage using all-solid-state batteries,” Nat. Nanotechnol., 2020, 15, 170-180 (“Tan I 2020”).
Tan, D. H. S., et al., “Sustainable design of fully recyclable all solid-state batteries,” MRS Energy Sustain., 2020, 7, E23 (“Tan II 2020”).
Wang, C., et al., “A general method to synthesize and sinter bulk ceramics in seconds,” Science, 2020, 368, 521-526 (“wang 2020”).
Wolfenstine, J., et al., “Mechanical behavior of Li-ion-conducting crystalline oxide-based solid electrolytes: a brief review,” Ionics, 2018, 24, 1271-1276 (“Wolfenstine 2018”).
Xiao, Y., et al., “Computational Screening of Cathode Coatings for Solid-State Batteries,” Joule, 2019, 3, 1252-1275 (“Xiao 2019”).
Yao, X., et al., “Interface Welding via Thermal Pulse Sintering to Enable 4.6 V Solid-State Batteries,” Adv. Energy Mater., 2024, 14, 2303422 (“Yao 2024”).
Zhu, L., et al., “Boron Nitride-Based Release Agent Coating Stabilizes Li_{1.3}Al_{0.3}Ti_{1.7}(PO₄)₃/Li Interface with Superior Lean-Lithium Electrochemical Performance and Thermal Stability,” Adv. Funct. Mater., 2022, 32, 2201136 (“Zhu 2022”).
Zhu, Y., et al., “First principles study on electrochemical and chemical stability of solid electrolyte-electrode interfaces in all-solid-state Li-ion batteries,” J. Mater. Chem. A, 2016, 4, 3253-3266 (“Zhu 2016”).
Zhu, Y., et al., “Origin of Outstanding Stability in the Lithium Solid Electrolyte Materials: Insights from Thermodynamic Analyses Based on First-Principles Calculations,” ACS Appl. Mater. Interfaces, 2015, 7, 23685-23693 (“Zhu 2015”).

What is claimed is:

1. A method comprising:
(a) selecting a used battery comprising a solid-state electrolyte; and
(b) subjecting the battery to heating and cooling in situ to regenerate the used battery.

2. The method of claim 1, wherein the subjecting the battery to the heating and cooling to regenerate the used battery comprises mitigating failure of the battery due to gap formation and reducing the buildup on interphases of the battery.

3. The method of claim 1, wherein
(a) the battery has gap formation resulting during battery cycling and side products accumulated after the battery cycling; and
(b) the subjecting the battery to the heating and cooling in situ enhances the performance of the battery upon usage by reducing the gap formation and the side product accumulated.

4. The method of claim 1, wherein the battery is a solid-state battery (SSB).

5. The method of claim 1, wherein the battery is a quasi-solid-state battery.

6. The method of claim 1, wherein the solid-state electrolyte is an LATP solid electrolyte.

7. The method of claim 1, wherein the heating is performed by flash Joule heating.

8. The method of claim 1, wherein the heating is performed by rapid thermal annealing.

9. The method of claim 1, wherein the battery comprises a small amount of liquid electrolyte.

10. The method of claim 9, wherein the liquid electrolyte comprises LiPF₆.

11. The method of claim 9, wherein the liquid electrolyte comprises a solubilized Li salt in a carbonate-based solvent, an ether-based solvent, or an ionic liquid.

12. The method of claim 1, wherein, after the subjecting the battery to the heating and cooling, the method further comprises adding liquid electrolyte to the battery.

13. The method of claim 12, wherein the battery is reconditioned, rejuvenated, and/or enhanced in its electrical performance after the adding of the liquid electrolyte.

14. The method of claim 1, wherein the battery comprises a high temperature sealant applied to a cell gap of the battery.

15. The method of claim 1, wherein the battery is reconditioned, rejuvenated, and/or enhanced in its electrical performance as a result of the heating and cooling.

16. The method of claim 1, wherein the heating is performed at a heating temperature between 150 °C and 1000 °C.

17. The method of claim 1, wherein the heating is performed at a heating temperature of at least 1000 °C.

18. The method of claim 1, wherein the heating is applied for a period between 1 second and 3 minutes.

19. The method of claim 1, wherein the heating is applied for a period of less than 1 second.

20. A system comprising:
(a) a source comprising a used battery comprising a solid-state electrolyte; and
(b) a battery heater and annealer, wherein the battery heater and/or annealer is operable to subject the battery to heating and cooling in situ to regenerate the used battery to a regenerated battery.
